(19) United States
(12) Patent Application Publication
(10) Pub. No.: US 2026/0112284 A1
(43) Pub. Date: Apr. 23, 2026

(54) SYSTEMS AND METHODS FOR IN-CAB FEEDBACK CONTROL USING VIRTUAL COACHING SESSIONS

(71) Applicant: NETRADYNE, INC., San Diego, CA (US)

(72) Inventors: Adam David Kahn, San Diego, CA (US); Rathnakumar UDAYAKUMAR, Hayward, CA (US); Kenneth Charles BOWEN, San Diego, CA (US)

(73) Assignee: NETRADYNE, INC., San Diego, CA (US)

(21) Appl. No.: 19/158,920

(22) PCT Filed: Mar. 1, 2024
(86) PCT No.: PCT/US24/18152

§ 371 Date: Aug. 22, 2025

Related U.S. Application Data
(60) Provisional application No. 63/449,931, filed on Mar. 3, 2023.
(60) Provisional application No. 63/453,260, filed on Mar. 20, 2023.

(51) Int. Cl. G09B 5/06; G07C 5/04; G07C 5/06

(52) U.S. Cl. CPC G09B 5/065; G07C 5/04; G07C 5/06

(57) ABSTRACT

A computing device of a vehicle and/or a remote computing device may generate a driving score tor a driver based on risky or unsafe driving behavior the driver engages in. The computing device can generate a driving score for the driver and monitor the driver over time to adjust or update the driving score. Tire computing device can initiate virtual coaching sessions in which the driver can access videos of tire driver engaging in. risky driving behavior to see when the risky driving behavior occurred. The computing device can determine whether the driver improved based on the driving score and/or determine whether the driver interacted with the 2024/186657 virtual coaching sessions. Responsive to determining the driver did not improve and/or interact with the virtual coaching sessions, the computing device can subsequently instruct the vehicle to generate alerts when the driver engages in similar risky driving behavior. WO

### CROSS-REFERENCE TO RELATED APPLICATIONS

This application claims the benefit of and priority to U.S. Provisional Patent Application No. 63/449,931 , filed Mar. 3, 2023 and U.S. Provisional Patent Application No. 63/453,260, filed Mar. 20, 2023, the entireties of which are incorporated by reference herein.

### TECHNICAL FIELD

This application relates generally to controlling the amount of notifications and content that is generated in vehicles based on driving behavior.

### BACKGROUND

Vehicles, such as automobiles, trucks, tractors, motorcycles, bicycles, airplanes, drones, ships, boats, submarines, and others are typically operated and controlled by human drivers. Through training and with experience, a human driver may learn how to drive a vehicle safely and efficiently in a range of conditions or contexts. For example, as an automobile driver gains experience, he may become adept at driving in challenging conditions such as rain, snow, or darkness.

Drivers may sometimes drive unsafely or inefficiently. Unsafe driving behavior may endanger the driver and other drivers and may risk damaging the vehicle. Unsafe driving behaviors may also lead to fines. For example, highway patrol officers may issue a citation for speeding. Unsafe driving behavior may also lead to accidents, which may cause physical harm, and which may, in turn, lead to an increase in insurance rates for operating a vehicle. Inefficient driving, which may include hard accelerations, may increase the costs associated with operating a vehicle.

Attempts to reduce unsafe driving behaviors have involved generating alerts that inform the driver of an upcoming obstacle or to alert the driver that the driver is engaging in risky driving behavior (e.g., drifting into an adjacent lane). However, even these alerts have their fair share of problems. For instance, the increasing complexity of in-vehicle alert systems has raised concerns about driver overload and distraction. Modern vehicles are equipped with a myriad of sensors and systems designed to monitor driving conditions, vehicle performance, and potential hazards. Each of these sensors and systems may generate alerts for different reasons, which can result in frequent alerts to a driver. While these alerts are intended to enhance safety by informing the driver of critical information in real-time, there is a growing body of evidence suggesting that an excessive number of alerts can have the opposite effect. Specifically, frequent interruptions can lead to cognitive overload, where the driver's ability to process information efficiently is compromised. This phenomenon, known as “alert fatigue,” can desensitize drivers to warnings, potentially leading to delayed reactions or the complete disregard of critical alerts. Consequently, the effectiveness of safety measures is diminished, and the risk of accidents may increase, highlighting the need for innovative solutions that balance the benefits of alert systems with the imperative to minimize driver distraction and cognitive overload.

### SUMMARY

Systems may attempt to avoid using alerts altogether by implementing driving coaching sessions for drivers that frequently engage in risky behavior. For example, a system may generate driving scores for drivers based on how the drivers drive and the amount of risky driving behavior the drivers engage in. The system may use driving scores to determine whether to implement a coaching session in which a coach (e.g., a person or an automated system) communicates with a bad driver (e.g., a driver with a low driving score) with instructions regarding how to improve their driving. The system may implement the coaching sessions for bad drivers to replace alerts and avoid alert fatigue. However, the coaching sessions are often not enough to improve the driving of bad drivers. For instance, while coaching sessions may be beneficial for educational purposes and improving specific driving skills, coaching sessions still lack the immediacy and real-time feedback necessary to address potential hazards or unsafe driving behaviors as they occur. The dynamic nature of driving environments can require instant alerts to inform drivers of unforeseen events, changes in road conditions, or immediate threats to safety, which coaching sessions may not be able to provide in real-time. Thus, there is a need for a system that improves bad driving of drivers in real time without causing alert fatigue.

Implementations of the systems and methods described herein may overcome the aforementioned technical problems by using virtual coaching sessions for selective alert generation. To do so, for example, a computing device of a vehicle and/or a remote computing device may generate a driving score for a driver based on risky or unsafe driving behavior the driver engages in (e.g., in driving events), such as running a stop sign or running a red light. The computing device can generate a driving score for the driver and monitor the driver over time to adjust or update the driving score. Responsive to determining the driving score did not change by an amount that satisfies a threshold, the computing device can initiate one or more virtual coaching sessions in which the driver can access videos of the driver engaging in risky driving behavior to see when the risky driving behavior occurred to avoid similar driving behavior in the future and/or view safe driving behavior for recognition or reinforcement of the safe driving behavior. The computing device can determine whether the driver improved based on the driving score and/or determine whether the driver accessed or otherwise interacted with the virtual coaching sessions. Responsive to determining the driver did not improve and/or access the virtual coaching sessions, the computing device can instruct the vehicle to generate auditory, visual, and/or haptic alerts when the driver engages in similar risky driving behavior in the future. In this way, the computing device can selectively enable driving alerts for the driver to avoid overloading the driver with alerts all at once, thus the computing device can operate to reduce risky driving in real time and avoid alert fatigue.

One embodiment is directed to a method that may include receiving, by one or more processors, visual data from a camera mounted on or in a vehicle; detecting, by the one or more processors, a plurality of driving events of a driving event type based on the visual data, the plurality of driving events corresponding to a driver driving a vehicle during the plurality of driving events; generating, by the one or more processors, a first score for a component of a driving score associated with the driving event type based at least on the plurality of driving events at a first time period; responsive to determining the first score satisfies a first threshold, segmenting, by the one or more processors for the driver, one or more video recordings of at least one of the plurality of driving events from the received visual data; presenting, by the one or more processors, a message configured to display the segmented one or more video recordings of the at least one of the plurality of driving events; generating, by the one or more processors, a second score for the component of the driving score at a second time period after presenting the message configured to display the segmented one or more video recordings of the at least one of the plurality of driving events; and in response to determining a change in value between the first score and the second score does not satisfy a second threshold and in response to detection of a new driving event of the driving event type, instructing, by the one or more processors, the vehicle to activate an audio or visual alert.

Detecting the plurality of driving events of the driving event type may include detecting, by the one or more processors, the plurality of driving events using a machine learning model on one or more features depicted in the visual data. Detecting the plurality of driving events of the driving event type using the machine learning model may include detecting, by an onboard processor located in or on the vehicle of the one or more processors, the plurality of driving events of the driving event type using the machine learning model.

Segmenting the one or more video recordings of the at least one of the plurality of driving events may include generating, by the one or more processors, a segment of video data for each of the at least one of the plurality of driving events, each segment depicting a different driving event of the at least one of the plurality of driving events; and storing, by the one or more processors, the segment of video data for each of the at least one of the plurality of driving events in a location in memory with an identifier of an account of the driver. Presenting the message configured to display the segmented one or more video recordings of the at least one of the plurality of driving events may include transmitting, by the one or more processors, the message comprising a pointer to the location in memory to a computing device associated with the account of the driver, the pointer configured to redirect an application executing on the computing device to access the segment of video data for each of the at least one of the plurality of driving events.

The method may further include determining, by the one or more processors, the second score for the component of the driving score has increased satisfies a third threshold subsequent to the instructing the vehicle to activate the audio or visual alert; and responsive to determining the second score for the component of the driving score satisfies the third threshold, transmitting, by the one or more processors, an instruction to the vehicle to stop activating the audio or visual alert for the driving event type. The method may further include determining, by the one or more processors, the driver has interacted with the one or more video recordings subsequent to the instructing the vehicle to activate the audio or visual alert; and responsive to determining the driver has interacted with the one or more video recordings, transmitting, by the one or more processors, an instruction to the vehicle to stop activating the audio or visual alert for the driving event type.

The method may include responsive to determining, by the one or more processors, that the driver has interacted with the one or more video recordings, extending, by the one or more processors, the second time period; and generating, by the one or more processors, the second score for the component of the driving score at the extended second time period after the presenting the message configured to display the segmented one or more video recordings of the at least one of the plurality of driving events. The method may further include in response to determining a change in value between the second score and a third score for the component of the driving score generated at a third time period after generation of the second score satisfies a third threshold, instantiating, by the one or more processors, a video conferencing portal between an account of the driver and an account of a driving coach.

The method may further include in response to determining a change in value between the first score and the second score does not satisfy the second threshold and in response to the detection of the new driving event of the driving event type, instructing, by the one or more processors, the vehicle to activate haptic feedback of one or more devices within the vehicle.

Another embodiment is directed to a system that can include one or more processors configured by machine-readable instructions to receive visual data from a camera mounted on or in a vehicle; detect a plurality of driving events of a driving event type based on the visual data, the plurality of driving events corresponding to a driver driving a vehicle during the plurality of driving events; generate a first score for a component of a driving score associated with the driving event type based at least on the plurality of driving events at a first time period; responsive to determining the first score satisfies a first threshold, segment, for the driver, one or more video recordings of at least one of the plurality of driving events from the received visual data; present a message configured to display the segmented one or more video recordings of the at least one of the plurality of driving events; generate a second score for the component of the driving score at a second time period after presenting the message configured to display the segmented one or more video recordings of the at least one of the plurality of driving events; and in response to determining a change in value between the first score and the second score does not satisfy a second threshold and in response to detection of a new driving event of the driving event type, instruct the vehicle to activate an audio or visual alert.

The one or more processors can be configured to detect the plurality of driving events of the driving event type by detecting the plurality of driving events using a machine learning model on one or more features depicted in the visual data.

An onboard processor can be located in the vehicle of the one or more processors is configured to detect the plurality of driving events of the driving event type using the machine learning model. The one or more processors can be configured to segment the one or more video recordings of the at least one of the plurality of driving events by generating a segment of video data for each of the at least one of the plurality of driving events, each segment depicting a different driving event of the at least one of the plurality of driving events; and storing the segment of video data for each of the at least one of the plurality of driving events in a location in memory with an identifier of an account of the driver.

The one or more processors can be configured to present the message configured to display the segmented one or more video recordings of the at least one of the plurality of driving events by transmitting the message comprising a pointer to the location in memory to a computing device associated with the account of the driver, the pointer configured to redirect an application executing on the computing device to access the segment of video data for each of the at least one of the plurality of driving events.

The one or more processors can be further configured to determine the second score for the component of the driving score has satisfies a third threshold subsequent to the instructing the vehicle to activate the audio or visual alert; and responsive to determining the second score for the component of the driving score satisfies the third threshold, transmit an instruction to the vehicle to stop activating the audio or visual alert for the driving event type.

Another embodiment is directed to a method that may include receiving, by one or more processors, visual data from a camera mounted on or in a vehicle; detecting, by the one or more processors, a plurality of driving events of a driving event type based on the visual data, the plurality of driving events corresponding to a driver driving a vehicle during the plurality of driving events; generating, by the one or more processors, a first score for a component of a driving score associated with the driving event type based at least on the plurality of driving events at a first time period; responsive to determining the first score satisfies a threshold, segmenting, by the one or more processors for the driver, one or more video recordings of at least one of the plurality of driving events from the received visual data; presenting, by the one or more processors, a message configured to display the segmented one or more video recordings of the at least one of the plurality of driving events; and in response to determining that the driver has not interacted with the one or more video recordings within a second time period after presenting the message configured to display the segmented one or more video recordings of the at least one of the plurality of driving events and in response to detection of a new driving event of the driving event type, instructing, by the one or more processors, the vehicle to activate an audio or visual alert.

The method can further include determining, by the one or more processors, a level of engagement for the driver based on playback of a number of the one or more video recordings, wherein determining the driver has not interacted with the one or video recordings comprises determining, by the one or more processors, the level of engagement for the driver is less than a second threshold. The method can include responsive to determining, by the one or more processors, that the first score for the component of the driving score has not increased within a defined time period after the presenting the message configured to display the segmented one or more video recordings of the at least one of the plurality of driving events, monitoring, by the one or more processors, activity of an account of the driver with the one or more video recordings; and responsive to determining, based on the monitoring, that the driver has not interacted with the one or more video recordings, instructing, by the one or more processors, the vehicle to activate the audio or visual alert for the driving event type.

Segmenting the one or more video recordings of the at least one of the plurality of driving events can include generating, by the one or more processors, a segment of video data for each of the at least one of the plurality of driving events, each segment depicting a different driving event of the at least one of the plurality of driving events; and storing, by the one or more processors, the segment of video data for each of the at least one of the plurality of driving events in a location in memory with an identifier of an account of the driver. Presenting the message configured to display the segmented one or more video recordings of the at least one of the plurality of driving events can include transmitting, by the one or more processors, the message comprising a pointer to the location in memory to a computing device associated with the account of the driver, the pointer configured to redirect an application executing on the computing device to access the segment of video data for each of the at least one of the plurality of driving events.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. Aspects can be combined and it will be readily appreciated that features described in the context of one aspect of the invention can be combined with other aspects. Aspects can be implemented in any convenient form. For example, by appropriate computer programs, which may be carried on appropriate carrier media (computer-readable media), which may be tangible carrier media (e.g., disks) or intangible carrier media (e.g. communications signals). Aspects may also be implemented using suitable apparatus, which may take the form of programmable computers running computer programs arranged to implement the aspect. As used in the specification and in the claims, the singular form of ‘a’, ‘an’, and ‘the’ include plural referents unless the context clearly dictates otherwise.

### BRIEF DESCRIPTION OF THE DRAWINGS

Non-limiting embodiments of the present disclosure are described by way of example with reference to the accompanying figures, which are schematic and are not intended to be drawn to scale. Unless indicated as representing the background art, the figures represent aspects of the disclosure. For purposes of clarity, not every component may be labeled in every drawing. In the drawings:

FIG. 1 illustrates an example environment showing a computing system for selective in-cab feedback control, according to an embodiment;

FIG. 2 illustrates a flow of a method for selective in-cab feedback control, according to an embodiment;

FIG. 3 illustrates a flow of a method for selective in-cab feedback control, according to an embodiment;

FIG. 4 illustrates a sequence for presenting segmented video recordings of driving events, according to an embodiment; and

FIG. 5 illustrates a scenario in which a cloud computing system instructs a vehicle to activate alerts for driving events of a driving event type, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

Alert systems can inform drivers when the drivers are engaging in risky driving behavior, which is intended to enhance road safety and improve driver behavior. Alert systems can be configured to generate auditory, visual, and/or haptic alerts upon detecting risky driving behavior, such as veering out of a lane or running a red light. Some alert systems inform drivers when their vehicles are close to contacting another object, such as another object or vehicle on the road. As systems have gotten more perceptive with an increasing number of sensors and event detection capabilities, the systems are generating more and more alerts. The increasing number of alerts may lead to alert fatigue in drivers that can cause the drivers to ignore the alerts completely and/or change the configurations of their vehicles to stop generating the alerts.

One attempt to reduce alert fatigue is to provide a more educational and preventative approach. For example, a system may implement driving coaching sessions for coaching drivers who frequently exhibit risky driving behavior. The system may initiate virtual coaching sessions in which the system generates videos of risky driving behavior and sends the videos to the driver for viewing. The videos may be generated from a lens simulating the driver's view (e.g., from the same or a similar perspective and/or viewpoint from inside the car) during the risky driving behavior. In some cases, the system may generate instructions on how the driver could have improved in driving situations they encountered. Other coaching sessions may include managed coaching sessions in which an individual coaches the risk drivers regarding how to improve their driving.

While virtual and/or managed coaching sessions may be effective, the coaching sessions may not provide real-time feedback that may be useful for drivers that encounter roadway scenarios in which the drivers are likely to engage in risky driving behavior. For certain habitual driving behaviors, real-time feedback presented during roadway scenarios for which a driver is likely to engage in the habitual behavior may activate physiological mechanisms that could help the driver solidify formation of a safer driving habit. In addition, the dynamic and unpredictable nature of driving environments often necessitates instant notifications to alert drivers to sudden changes in road conditions, unforeseen events, or immediate safety threats. This gap in the coaching model underscores the need for a system that can offer real-time improvement in driving behavior without leading to the overuse of alerts, which may desensitize drivers.

To address these technical challenges, a computer or computing system implementing the systems and methods described herein may implement a selective alert generation process that may utilize both real-time alerts and coaching sessions for drivers, including both risky and positive driving actions. The computer can monitor the driver behavior of a driver (or any number of drivers) over time, identifying different driving events in which the driver engages in risky or unsafe driving and/or safe driving. The computer can determine the types of the driving events and generate a driving score for the driver based on the driving events and the types of the driving events. The computer can generate video recordings (also referred to herein as videos) of driving events of the driving event type in which the driver engaged in risky driving behavior and/or safe behavior. The driving score may indicate a safety level of the driver when driving. Responsive to determining the driving score is below a threshold, the computer can provide the driver with access to the videos, such as by storing the videos in memory and transmitting a message to the driver (e.g., a computer accessed by the driver) containing a pointer (e.g., a hyperlink) that the driver can select to access the driving videos. The computer can continue monitoring the driver's performance after transmitting the message and/or determine whether the driver interacted with (e.g., viewed) the videos. Responsive to determining the driver's driving score has not improved after a defined time period from transmitting the message and/or that the driver has not viewed or interacted with the videos, the computer may generate instructions for the driver's vehicle to generate an alert (e.g., an audio, visual, and/or haptic alert) responsive to detecting a driving event or an upcoming driving event for the driving event type. Accordingly, the computer can implement a combination of in-cab feedback and coaching sessions to improve driving behavior while still providing real-time alerts to enhance driving safety.

In some cases, to determine whether a driver interacts with videos of virtual coaching sessions, the computer may trigger actions based upon a level of engagement. The level of engagement may indicate the number, percentage, portion, and/or ratio of videos of driving events that the driver views or accesses compared with the number of videos of driving events that the computer generates or provisions for access to the driver. The computer may maintain a counter of the number of videos the driver accesses and increment the counter for each video that the driver views or accesses. The computer may compare the count of the counter to a number of videos the computer generated for the driver (which may be a predetermined number) to determine the level of engagement for the driver. The computer may determine the driver has not interacted with the videos responsive to determining the level of engagement is below a threshold. Responsive to determining the driver has not interacted with the videos, the computer may generate instructions to activate alerts for the driver in the vehicle when the driver is driving the vehicle and encounters a driving event.

The computer may be configured to generate instructions for alerts and/or videos for driving events for a specific driving event type (also referred to herein as type of driving event). For example, when generating the driving score for the driver, the computer may generate the score based on or as a function of components of the driving score that correspond to specific types of driving events (e.g., stop lights, red lights, narrow roads, staying within a lane, following distance, etc.). The computer may determine driving events that correspond to the types of driving events as the driver drives and generate a separate score for each type of driving event (e.g., each component of the driving score). The computer may determine when a score for a particular type of driving event is below a threshold and generate videos for driving events based on which the computer generated the score. The computer can then generate instructions for the vehicle to generate alerts responsive to determining the driver did not watch the videos and/or determining that the score for the type of driving event has not changed by an amount that satisfies a threshold and responsive to detecting a new driving event of the same driving event type.

In a non-limiting example, the computer can receive images from a camera located in a housing (e.g., a plastic, metal, or other solid material that can store or hold the camera) inside a cabin of a vehicle. The computer can be inside or local to the vehicle and/or be located in a remote computer, such as a cloud server. The computer can detect driving events of a driving event type in which a driver of the vehicle engaged in risky or unsafe driving behavior (e.g., running a red light). The computer can segment videos depicting the driving events of the driving event type. The computer can generate a driving score for the driving event type for the driver based on such driving events that the computer detects over time for the driver. Responsive to determining the driving score is less than a threshold, the computer can provide the driver with access to the videos in virtual coaching sessions. After provisioning the videos, the computer can monitor the driver's driving behavior and/or whether the driver accesses the videos. Responsive to determining the driving score for the driver has not improved above a threshold and/or determining the driver has not accessed the videos after provisioning the videos and responsive to detecting one or more events of the driving event type, the computer can generate instructions for the vehicle to activate audio, visual, and/or haptic alerts to alert the driver of the driving event type.

### Selective In-Cab Feedback Control using Virtual Coaching Sessions

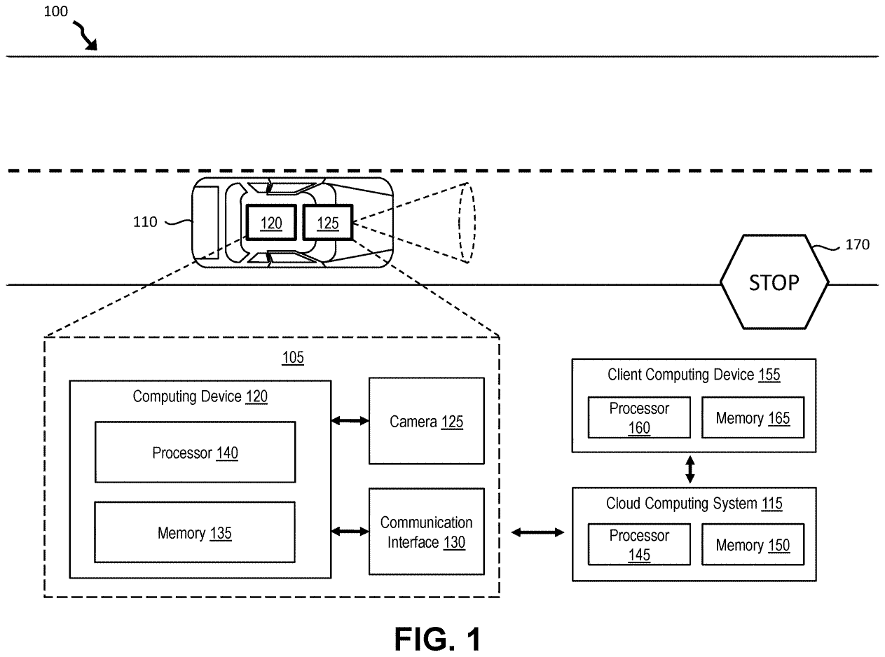

FIG. 1 depicts an example environment that includes example components of a system in which such a computer can selectively generate instructions to generate alerts for driving events of different driving event types. Various other system architectures may include more or fewer features and/or may utilize the techniques described herein to achieve the results and outputs described herein. Therefore, the system depicted in FIG. 1 is a non-limiting example.

FIG. 1 illustrates a system 100, which includes components of an object detection system 105 for detecting objects within images captured by a camera attached to or integrated on or within a vehicle 110. The system 100 can include the vehicle 110, the object detection system 105, and/or a cloud computing system 115. The object detection system 105 can include a computing device 120, a camera 125, and/or a communication interface 130. The object detection system 105 may include an alert device, such as an audio alarm, a warning light, another type of visual indicator, and/or a haptic feedback device (e.g., one or more vibrating seats or a vibrating steering wheel). The object detection system 105 can be mounted on a dashboard, windshield, or other area inside the vehicle 110. The system 100 is not confined to the components described herein and may include additional or other components, not shown for brevity, which are to be considered within the scope of the embodiments described herein.

The vehicle 110 can be any type of vehicle, such as a car, truck, van, sport-utility-vehicle (SUV), motorcycle, semi-tractor trailer, or other vehicle that can be driven on a road or another environment. The vehicle 110 can be operated by a user, or in some implementations, can include an autonomous vehicle control system (not pictured) that navigates the vehicle 110 or provides navigation assistance to an operator of the vehicle 110. The vehicle 110 can be a vehicle of a fleet of vehicles that are owned and/or operated by an entity (e.g., a business or organization) to transport goods, materials, and/or individuals.

The vehicle 110 can include the object detection system 105, which can be used to detect objects within images captured by the camera 125 when the vehicle is parked and/or as the vehicle is driving down a road. As outlined above, the object detection system 105 can include a computing device 120. The computing device 120 can be mounted on or in the vehicle 110. In some cases, the computing device 120 is a computing device that automatically controls the vehicle for self-driving. The computing device 120 can include at least one processor 140 and the memory 135, (e.g., a processing circuit, etc.). The memory 135 can store processor-executable instructions that, when executed by the processor 140, cause the processor 140 to perform one or more of the operations described herein. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing the processor with program instructions. The instructions may include code from any suitable computer programming language.

The computing device 120 can include the memory 135, which can store images and/or video captured by the camera 125. The memory 135 can be a computer-readable memory that can store or maintain any of the information described herein that is generated, accessed, received, transmitted, or otherwise processed by the computing device 120. The memory 135 can maintain one or more data structures, which may contain, index, or otherwise store each of the values, pluralities, sets, variables, vectors, numbers, or thresholds described herein. The memory 135 can be accessed using one or more memory addresses, index values, or identifiers of any item, structure, or region of memory maintained by the memory 135.

The memory 135 may be internal to the computing device 120 or may exist externally to the computing device 120 and accessed via a suitable bus or interface. In some implementations, the memory 135 can be distributed across many different storage elements. The computing device 120 (or any components thereof) can store, in one or more regions of the memory of the memory 135, the results of any or all computations, determinations, selections, identifications, generations, constructions, or calculations in one or more data structures indexed or identified with appropriate values.

The computing device 120 can include or be in communication with a communication interface 130 that can communicate wirelessly with other devices. The communication interface 130 of the computing device 120 can include, for example, a Bluetooth communications device, a Wi-Fi communication device, or a 5G/LTE/3G cellular data communications device. The communication interface 130 can be used, for example, to transmit any information described herein to the cloud computing system 115, including images and/or videos that the computing device 120 receives from the camera 125. The communication interface 130 can also be used, for example, to receive indications of driving events that the processor 140 detects from the images or videos, in some cases with the images or videos from which the processor 140 detects the driving events.

The camera 125 can include any type of camera or multiple cameras that are capable of capturing images or videos of the environment surrounding the vehicle 110 and/or within the vehicle 110, including a configuration having an external camera view of the surrounding environment and a cabin-facing camera view of the driver. The camera 125 may periodically capture images or video while the vehicle 110 is turned on and parked and/or as the vehicle 110 is moving. For example, the camera 125 can capture an image or video of a stop sign 170 as the vehicle 110 approaches or passes the stop sign 170. In another example, the camera 125 can capture an image or video of the driver before, during, and/or after a driving event. In some cases, the camera 125 can capture images or video when the vehicle 110 is turned off (e.g., when the vehicle is off but in a surveillance mode). The camera 125 may capture images or videos and transmit the images or videos to the computing device 120. The computing device 120 may receive the images or videos and store images or videos in the memory 135 and/or transmit the images or videos to other vehicles or to the cloud computing system 115.

The cloud computing system 115 can be or include one or more computing devices that are configured to evaluate video and/or image data (e.g., visual data) to detect driving events and generate scores for drivers based on the detected driving events. The cloud computing system 115 can include one or more processors 145 and/or memory 150. The cloud computing system 115 may receive images or videos from computing devices of different vehicles (e.g., the vehicle 110) and use techniques to detect driving events from the video and/or image data. Driving events can be any driving incident that the cloud computing system 115 is configured to detect. Driving events can be or include negative driving incidents on the road, such as a vehicle running a red light, a vehicle running a stop sign, a vehicle swerving outside of the vehicle's lane, a vehicle speeding, etc. In some cases, the cloud computing system 115 can detect positive driving incidents as driving events, such as following the speed limit, staying within a lane, stopping at a red light or stop sign, etc. The cloud computing system 115 may be configured to use rules and/or machine learning techniques (e.g., a neural network, a random forest, a support vector machine, etc.) to detect driving events of different driving event types from images or videos. For example, the cloud computing system 115 can execute a neural network using one or more images of a video as input to detect driving events for a vehicle. The cloud computing system 115 can use any combination of rules and/or a machine learning model to detect driving events.

The cloud computing system 115 may use parallel processing techniques or have different computers perform different tasks to facilitate the operations described herein. For example, one computer of the cloud computing system 115 can establish connections with the computers of vehicles to receive images from object detection systems of the vehicles (e.g., the object detection system 105), another computer of the cloud computing system 115 can process the received images to detect driving events, another computing of the cloud computing system 115 can segment the images into videos that depict different events, and another computer of the cloud computing system 115 can establish a connection with client computing devices, such as a client computing device 155, to present videos of the driving events in virtual coaching sessions. Any combination of one or more of the computers of the cloud computing system 115 and/or the object detection system 105 may perform such processes.

A client computing device 155 can be a computer that is configured to receive messages and/or present messages or other data on a user interface. The client computing device 155 can include a processor 160 and a memory 165. The client computing device 155 can be any type of computing device, such as a mobile phone, laptop computer, desktop computer, smart watch, gaming console, personal data assistant, dashboard computer, or other computing device. A driver associated with the vehicle 110 can own or otherwise access the client computing device 155 to access a platform provided by the cloud computing system 115 that manages accounts for different drivers (e.g., drivers of a driver fleet managed by the cloud computing system 115). The driver can access the platform through the account for the driver that the cloud computing system 115 stores in the memory 150.

The camera 125 can communicate with the computing device 120 via a vehicle interface, which may include a CAN bus or an on-board diagnostics interface. The camera 125 can capture images or video and transmit the captured images or video to the computing device 120. The computing device 120 can receive the captured images or video and transmit the images or video to the cloud computing system 115 to use to detect driving events for a driver of the vehicle 110.

The cloud computing system 115 may receive the images and use the images to detect driving events and types of the driving events from the images. The cloud computing system 115 can receive the images and detect the driving events as the driver is driving the vehicle 110 and/or after the driver stops driving the vehicle 110. In some cases, the cloud computing system 115 can determine the rules that are satisfied based on sensor data generated by sensors of the vehicle, such as an accelerometer, a speedometer, etc. In some cases, the cloud computing system 115 can classify the driving events into the types of the driving events. For example, the cloud computing system 115 can classify detected driving events into different driving event types such as the vehicle running a red light, the vehicle running a stop sign, the vehicle swerving outside of the vehicle's lane, the vehicle speeding, etc. The cloud computing system 115 can classify the driving events by identifying the rules that were satisfied to detect the driving events and/or by identifying a classification label output by the machine learning model that detected the driving events from the images. The cloud computing system 115 can classify the driving events by labeling the driving events (e.g., portions of a video stream or sets of images) with labels indicating the classifications.

In some cases, the computing device 120 can segment the visual data based on driving events that the computing device 120 detects. For example, the computing device 120 can detect driving events and/or driving event types using rules and/or a machine learning model in the same or similar manner to the manner described above with respect to the cloud computing system 115. The computing device 120 can detect the driving events and/or driving event types and generate video recordings of the driving events. The computing device 120 can transmit the video recordings to the cloud computing system 115, in some cases with the labels generated using the rules and/or the machine learning model. The cloud computing system 115 can receive the video recordings and/or labels and store the video recordings and/or labels in the memory 150.

The cloud computing system 115 can generate a driving score for the driver. The cloud computing system 115 can generate the driving score based on driving events that the cloud computing system 115 detects and/or has stored in memory after receiving from the computing device 120. For example, the cloud computing system 115 can generate a driving score for the driver (e.g., account for the driver) of the vehicle 110 based on driving events from images or videos that were captured by the camera 125 while the driver was driving the vehicle 110. The cloud computing system 115 can evaluate the driving events according to a set of rules or criteria, such as by increasing the driving score for the driver for positive driving events and/or decreasing the driving score for negative driving events.

In some cases, the cloud computing system 115 can generate scores for components of the driving score that correspond to different driving types of driving events. For example, the cloud computing system 115 can identify the types of the driving events that the cloud computing system 115 detects from images or videos of the driver driving the vehicle 110. The cloud computing system 115 can generate a score (e.g., a component score) for each type of driving event or for different subsets of driving event types. For instance, the cloud computing system 115 can generate a score for following distance based on the number of driving events in which the cloud computing system 115 detects the vehicle 110 tailgating (e.g., being within a predetermined distance of a vehicle in front of the vehicle 110; in some cases, the predetermined distance can vary based on the speed of the vehicle 110). The cloud computing system 115 can generate the score for the following distance driving event type based on the number of instances in which the cloud computing system 115 detects a driving event in which the vehicle 110 is within a predetermined threshold of another vehicle in front of the vehicle 110 and/or based on a ratio or percentage of the time in which the vehicle 110 is tailgating compared with the times the vehicle 110 is not tailgating with the driver behind the wheel. The cloud computing system 115 can similarly generate scores for any number of components based on detected driving events for the driver.

The cloud computing system 115 can generate the driving score for the driver based on or as a function of the scores for the components of the driving scores. For instance, the cloud computing system 115 can generate a driving score for the driver as an average, weighted average, median, etc., of the scores for the components that the cloud computing system 115 generates for the driver. For example, the cloud computing system 115 can generate the driving score using a function such as driving score=w₁(tailgating score)+w₂(stop at stop signs score)−w₃(non-compliance score) . . . +Wₙ(follow speed limit score). The cloud computing system 115 can generate the driving score using any method or function.

In some cases, the cloud computing system 115 can generate one or more virtual coaching sessions for the driver responsive to determining a score for a component of the driving score associated with a driving event type satisfies (e.g., is less than or greater than, depending on the configuration) a threshold (e.g., a first threshold.). The virtual coaching sessions can be or include videos of driving events based on which the cloud computing system 115 determined the scores for the driver. The cloud computing system 115 can generate the virtual coaching sessions by identifying and/or segmenting video recordings of driving events that the cloud computing system 115 and/or the computing device 120 detected that caused the cloud computing system 115 to generate the score for the driving event type. For example, responsive to determining the score for the driving event type is less than the threshold, the cloud computing system 115 can identify video recordings of one or more driving events (e.g., a defined number of video recordings) that caused the cloud computing system 115 to generate the score for the driving event type. The video recordings may depict negative driving events, such as driving events in which the driver engaged in risky or unsafe driving behavior (e.g., tailgated another vehicle, ran a red light or a stop sign, broke the speed limit, etc.) and/or positive driving events, such as driving events in which the driver engaged in safe driving behavior (e.g., following the speed limit or driving an appropriate distance behind another vehicle). The cloud computing system 115 can store a flag or indication in memory or the account of the driver with the video recordings to indicate the video recordings have been selected for presentation in virtual coaching sessions such that the driver can access, view, or otherwise interact with the video recording to see which areas in the driver's driving can improve.

The cloud computing system 115 can transmit a message to the client computing device 155. The cloud computing system 115 can transmit the message responsive to generating the virtual coaching sessions for the driver of the vehicle 110 and/or segmenting the video recordings for the virtual coaching sessions. The cloud computing system 115 can generate the message to contain a pointer (e.g., a hyperlink) for the driver to access the videos from the driver's account. The driver can select the pointer to cause the client computing device 155 to request or access a page or the videos from the cloud computing system 115.

In some cases, when transmitting the message to the client computing device 155, the cloud computing system 115 can transmit the message to an application (e.g., a mobile application) executing on the client computing device 155. The application may be configured to be or include an application programming interface (API) to communicate with the cloud computing system 115 to access the platform provided by the cloud computing system 115. The cloud computing system 115 can transmit the message to the application via the API, and the user can view the message through the application.

The application executing on the client computing device 155 can be configured to provide access to the videos. For example, the driver can select the pointer from the message using the client computing device 155. Responsive to selecting the pointer, the application can retrieve the videos from the cloud computing system 115 that the cloud computing system 115 store in the account for the driver and transmit the videos to the client computing device 155 through the application. The driver can select the videos to watch by selecting options or buttons in the application that initiate playback of the videos.

The cloud computing system 115 can monitor changes in the driving score over time after generating the virtual coaching sessions. For example, the cloud computing system 115 can generate the driving score, and/or scores for individual components of the driving score, for the driver based on driving events that the cloud computing system 115 detects within a time period (e.g., a first time period) or from images that were captured within the time period (e.g., correspond to a timestamp within the time period) and that caused the cloud computing system 115 to generate the virtual coaching sessions. The time period can have a duration relative to the current time (e.g., the previous week) and may be stored in memory. After generating the virtual coaching sessions, the cloud computing system 115 can detect further or new driving events. The cloud computing system 115 may update the initially generated first driving score and/or the corresponding component scores for each newly detected driving event, such as by recalculating the driving score for each driving event, or generate the second driving score at the end or responsive to detecting the end of another time period (e.g., a second time period, such as a week) after the time the cloud computing system 115 initially generated the virtual coaching sessions. In some cases, the cloud computing system 115 can generate a second driving score and the corresponding component scores for the driver based only on driving events detected during the second time period. In some cases, the cloud computing system 115 may only update the score for the driving event type for which cloud computing system 115 generated virtual coaching sessions. The cloud computing system 115 can generate or identify the score for the driving event type for the driver of the vehicle 110 at the end of the second time period and determine a change in the score for the driving event type between the beginning and end of the second time period. In some cases, the cloud computing system 115 can determine a change in score (e.g., a change in value) between the first score for the driving event type based on which the cloud computing system 115 generated the virtual coaching sessions and the second score for the driving event type.

The cloud computing system 115 can determine to activate in-cab feedback for the vehicle and/or driver based on changes in scores for driving event types. For example, the cloud computing system 115 can determine a first score for a driving event type for the driver of the vehicle 110 satisfies a first threshold (e.g., a first predetermined threshold). The cloud computing system 115 can determine whether the first score satisfies the first threshold by determining whether the first score is below or above the first threshold, depending on the configuration of the cloud computing system 115. Responsive to determining the first score satisfies the first threshold, the cloud computing system 115 can generate virtual coaching sessions (e.g., segment video recordings of driving events and/or provision the segmented video recordings for access and/or viewing) for the driver. Virtual coaching sessions can be or include the video recordings of the driving events. The cloud computing system 115 can determine a second score for the driving event type at the end of a second time period after the cloud computing system 115 generated the first score (e.g., after any other defined time). The cloud computing system 115 can compare the change in value between the two scores to a second threshold (e.g., a second predetermined threshold). Responsive to determining the change in the score does not satisfy (e.g., is less than or is greater than, depending on the configuration of the cloud computing system 115) the second threshold, the cloud computing system 115 can determine to generate instructions to activate in-cab feedback (e.g., an audio, visual, and/or haptic alert) for the driver (e.g., for the vehicle 110 that the driver operates). In some cases, the cloud computing system 115 can generate such instructions using the driving score itself rather than or in addition to a score for a particular driving event type.

The cloud computing system 115 can generate instructions for the vehicle 110 to activate the alert in response to detection of a new driving event. For example, responsive to determining the score changed by a value that does not satisfy the second threshold, the cloud computing system 115 can generate instructions that cause the vehicle 110 to activate an audio, visual, and/or haptic alert responsive to the vehicle 110 or the cloud computing system 115 detecting a new driving event using real-time data (e.g., images that are captured as the driver is driving the vehicle 110). The cloud computing system 115 can transmit the instructions to the vehicle 110 to instruct the vehicle 110 to generate the alerts. The vehicle 110 can execute the instructions to configure or reconfigure the vehicle 110 such that when a new driving event is detected (e.g., by the computing device 120 or the cloud computing system 115), the vehicle 110 can activate (e.g., automatically activate) an audible, visual, and/or haptic alert within the vehicle 110. In some cases, the cloud computing system 115 can generate the instruction for each new driving event that the cloud computing system 115 or the object detection system 105 detects and activates the alert on a per-new driving event basis.

In one example, the cloud computing system 115 may instruct the vehicle 110 to activate the alert responsive to detection of a new driving event of a driving event type for which the cloud computing system 115 generated the virtual coaching sessions. For example, the cloud computing system 115 may determine a first score for a component of the driving score for the driver that corresponds to running a red light. Based on the first score, the cloud computing system 115 may generate videos (e.g., described herein as videos or video recordings) depicting the driver running through red lights with the vehicle 110 that caused the cloud computing system 115 to generate the first score that satisfies the first threshold. The cloud computing system 115 can determine a second score for the component of the driving score for the driver that corresponds to running a red light a defined time period after generating the virtual coaching sessions and determine a change in value between the first score and the second score does not satisfy (e.g., does not exceed) a second threshold. Responsive to doing so, the cloud computing system 115 can generate instructions that are configured to cause the vehicle 110 to generate an alert when approaching a red light. The cloud computing system 115 can selectively configure the vehicle 110 to generate alerts for any type of driving event in this manner.

In some cases, instead of or in addition to generating instructions that instruct the vehicle 110 to generate alerts for new driving events or new driving events of a driving event type (e.g., a particular driving event type) responsive to determining a score does not improve, the cloud computing system 115 can generate the instructions responsive to determining the driver has not interacted with the videos within a second time period after generating the virtual coaching sessions. For example, the cloud computing system 115 may monitor the account of the driver after generating the virtual coaching sessions or transmitting the message containing the pointer to the videos to the client computing device 155. Responsive to determining the user never interacted with (e.g., never played or accessed) the videos, the cloud computing system 115 can generate instructions to generate alerts for new events (e.g., new driving events of a driving event type) and transmit the instructions to the computing device 120. The computing device can operate according to the instructions. Accordingly, the cloud computing system 115 can selectively control or instruct the computing device 120 to generate alerts for driving events in cases in which the driver is not improving based on the virtual coaching sessions and/or in cases in which the driver is not interacting with the virtual coaching sessions.

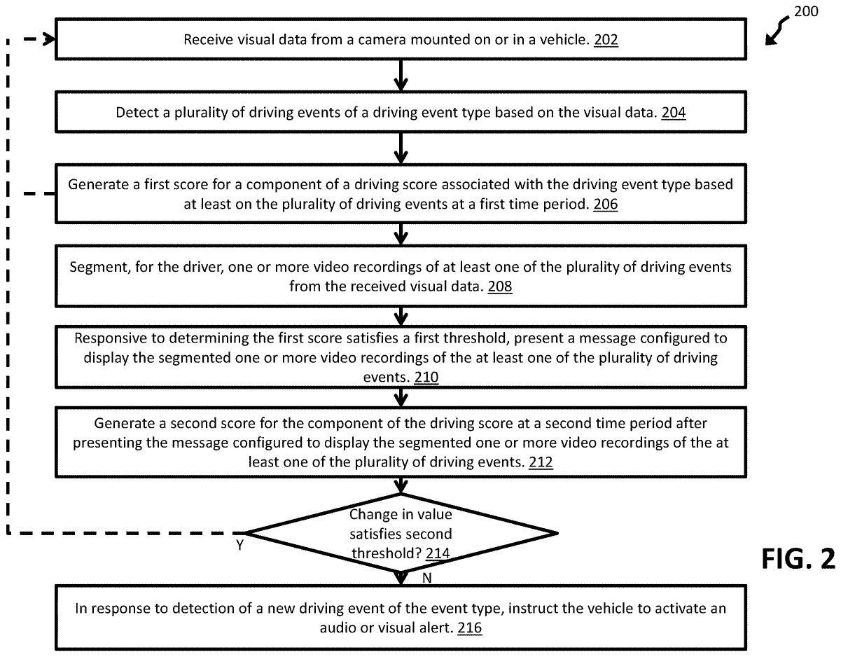

FIG. 2 illustrates a flow of a method 200 executed by a data processing system. The data processing system can be or include a computing system of a vehicle (e.g., the object detection system 105) and/or a remote computing system (e.g., a cloud server or the cloud computing system 115) for selective alert generation, in accordance with an embodiment. The method 200 is shown to include steps 202-216. However, other embodiments may include additional or alternative steps, or may omit one or more steps altogether. Different steps can be performed by different computing systems (e.g., the computing system of the vehicle can perform one or more of the steps 202-216 and/or the remote computing system can perform one or more of the steps 202-216) and/or the different computing systems and can operate together to perform individual steps of the steps 202-216.

In step 202, the data processing system receives visual data. The visual data can be or include one or more images or one or more video streams. The visual data can be or include a JPEG, RAW, or another image file type. The visual data can be or include imagery of a road or the area surrounding a vehicle or inside the vehicle. The visual data can be or include one or more standalone images or one or more frames of a video. The data processing system can receive the visual data from a camera attached to or inside the vehicle. The data processing system can receive the visual data as a driver is driving the vehicle or when the driver has parked the vehicle and/or when the vehicle is in a standby mode. The data processing system can receive such visual data at defined intervals in the case of static standalone images or as the camera streams a video to the data processing system in a sequence of frames.

In step 204, the data processing system detects a plurality of driving events. The data processing system can detect the plurality of driving events from the visual data. The data processing system can detect the driving events using an onboard processor located in or on the vehicle or by a processor located in the cloud (e.g., a processor of a cloud server). The data processing system may detect the plurality of driving events by applying one or more rules to the frames of the visual data or by executing a machine learning model (e.g., a neural network, a support vector machine, a random forest, etc.) configured or trained to detect driving events from input visual data. The data processing system may detect the driving events from the visual data by determining a rule is satisfied (e.g., determining a set of images depicts a red light) or by executing the machine learning model and identifying the output as a driving event. The data processing system may determine driving events that indicate incidents that occurred while the driver was driving. The data processing system can detect negative driving events such as a vehicle (e.g., the vehicle being driven by the driver) running a red light, the vehicle running a stop sign, the vehicle swerving outside of the vehicle's lane, the vehicle speeding, etc., and/or positive driving incidents, such as the vehicle following the speed limit, the vehicle staying within a lane, the vehicle stopping at a red light or stop sign, etc. The data processing system can detect any type of driving event. The data processing system can label images and/or portions of video feeds depicting the driving events with labels indicating the driving events. In some cases, the onboard processor transmits videos of the detected driving events and/or the labels indicating the driving events to a cloud computing device of the data processing system for further processing (e.g., to determine a driving score for the driver of the vehicle), in some cases with the labels that the onboard processor determines for the videos.

The data processing system can detect specific types of driving events. In one example, the rules that the data processing system is configured to use to detect events can correspond to specific driving event types (e.g., speeding, running a red light, running a stop sign, etc.). For instance, the data processing system can detect objects and/or the locations of such objects in images (e.g., using object detection machine learning techniques) on sequential images of the visual data. The data processing system can compare the objects to the rules and determine the objects and/or locations of the objects of a rule corresponding to running a stop sign satisfy the rule. Accordingly, the data processing system can detect a driving event from the visual data indicating a driving event in which the vehicle runs the stop sign. In another example, the data processing system can store and/or execute a machine learning model that has been trained or configured to detect driving events as well as the types of the driving events based on features and/or objects depicted in individual images and/or sequences (e.g., consecutively captured) of images. The data processing system can feed images and/or a video feed into the machine learning model and execute the machine learning model to cause the machine learning model to output an indication of the driving event and a type of the driving event. The data processing system can identify the driving event and the type of the driving event from the output. The data processing system can include a label of the type of the driving event with the driving event label on the images and/or the portions of the video feeds that depict the respective driving events. In some cases, the data processing system can label the images and/or portions of the videos (e.g., video recordings) to indicate whether the driving event is positive or negative (e.g., indicate safe or unsafe driving behavior), which the data processing system may similarly determine based on the rules that are satisfied and/or the output of the machine learning model. The data processing system can detect any number of driving events for any number of driving event types from visual data from individual vehicles.

In step 206, the data processing system generates a first score for a component of a driving score associated with a driving event type. The data processing system can generate the first score for a vehicle. The driving score may indicate a safety or risk score for the driver of the vehicle based on driving events (e.g., an aggregation of driving events) that the data processing system detects from visual data generated when the driver was driving the vehicle or other similarly equipped vehicle. The data processing system can generate the first score based on driving events that correspond with the component of the driving score associated with the driving event type. For example, the data processing system can identify driving events that each correspond to a driving event type of approaching a stop sign. The data processing system can do so by identifying driving events labeled with the driving event type of approaching a stop sign. From the driving events, the data processing system can identify the number of driving events in which the driver stopped at a stop sign and a number of driving events in which the driver rolled through or otherwise ignored the stop signs. The data processing system may determine a higher score for the driving event type (and driving score) for each driving event in which the driver stopped at a stop sign and a lower score for the driving event type (and driving score) for each driving event in which the driver rolled through or ignored a stop sign. The data processing system can use any function and/or method when determining scores for types of driving events. The data processing system can determine scores for any number of types of driving events.

The data processing system can determine the driving score for the driver based on the scores for the different components associated with the driving event types. For example, the data processing system can determine a weighted average of the different scores in which the different driving event types are assigned different weights and the data processing system determines a weighted average. Other examples of functions may be an average or median of the scores. The data processing system may be configured to generate scores for the driving event types and/or the driving score to be within a defined range (e.g., 0-100).

The data processing system may determine the first score for the component of the driving score associated with the driving event type for driving events that occurred or that were detected within a moving time window. For example, the data processing system may detect and/or label driving events of different driving event types for the driver over time. The data processing system may determine scores for the different driving event types and/or the driving score for the driver for each detected driving score and/or at set intervals. In doing so, the data processing system may only use driving events that occurred within a predetermined time period relative to the current time (e.g., within the past week, month, or year). Accordingly, the data processing system can determine up-to-date driving statistics for drivers that is not biased by stale data, and that may track, for example, the driver's recent improvements in safe driving habits.

In one example, the data processing system can determine summary scores of each driver. For instance, a driver's score may be based on a raw count of observed unsafe behaviors. Alternatively, a driver's score may be based on a normalized count of observed unsafe behaviors, such as a count of observed unsafe behaviors that is normalized by a number of opportunities to exhibit such behavior, miles driven, period of time and the like. For example, a driver's score for stop sign behavior in a given period of time may be computed as a number of times that a driver rolled through a stop sign divided by (normalized by) the number of stop signs that the driver encountered in that period of time. In addition, observed unsafe driving behaviors may be weighted according to the severity of individual events in relation other events in the same class of driving events. Continuing with the stop sign behavior score example, the score may be weighted based on the speed at which a driver rolled through certain stop signs.

The summary score for a driver may include multiple components. For example, in addition to a score component for stop sign behavior, described above, a second score component may reflect the driver's traffic light behavior. This component may be computed in an analogous fashion. For a given period of time, the number of times that the driver passed through an intersection when a traffic light corresponding to the driver's lane and direction of travel was red (a traffic light violation) may be divided by the total number of intersections with traffic lights that the driver encountered. Furthermore, individual traffic light violations that contribute to the summary traffic light component score may be weighted depending on a determined severity of the violation, where the severity may depend on the density of traffic at the intersection, the amount of time that the driver had to stop before the light turned red, the distance to the traffic light when it turned yellow or red, and the like.

In an embodiment in which a driver's score includes multiple components, each of the components may be weighted differently in a manner that reflects a relative priority of the behavior. Continuing with the example above, a driver's score may include a stop sign component and a traffic light component. Considering that historical data may show that more accidents occur when a driver runs a red light than when a driver rolls through a stop sign, the traffic light component may be weighted more heavily. Accordingly, a driver's composite score may provide a summary metric that correlates with accident risk, accident risk weighted by expected loss, and the like.

Other driving score components may be based on continuous measures of driving compliance. For example, a speeding component score may consider the amount of time spent driving below a posted or fleet-specific speed limit. In some embodiments, the speeding score may be based on duration and severity of speeding normalized by the amount of time that the driver was travelling faster than 10 miles per hour less than the speed limit (to restrict the analysis to times that the driver could have been speeding). By normalizing in this way, a speeding score component may be more fairly compared across drivers who spend relatively more or less time in dense traffic when speeding is not even practical.

The data processing system can determine whether the first score for the component of the driving score satisfies a first threshold. For example, the data processing system can determine the first score for the component of the driving score associated with the driving event type as the score for a first time period (e.g., a fixed time period of the moving time window relative to the current time in which the data processing determines the first score). The data processing system can compare the first score to the first threshold (e.g., a first predetermined threshold). The data processing system can determine whether the first score satisfies (e.g., is less than or is greater than, depending on the configuration or the driving event type) the first threshold based on the comparison. Responsive to determining the first score does not satisfy the first threshold, the data processing system may continue monitoring the driving event types and repeat steps 202-206 over time.

In some cases, the data processing system can determine whether the first score for the component of the driving scores satisfies the first threshold based on the driving event type that corresponds to the component of the driving score. For example, for some driving score configurations, a higher score indicates a higher degree of safety and the safety score increases with detected examples of positive driving (e.g., following the speed limit, stopping at stop signs, stopping at traffic lights, etc.) while for other driving score configurations, a higher score indicates a lower degree of safety, and the score increases with detected negative examples (e.g., non-compliance: speeding, failing to stop at a stop sign, running a red light). The data processing system can determine the first score satisfies the first threshold for driving event types in which higher scores indicate higher degrees of safety when the first score is lower than the first threshold and the opposite for driving score configurations in which higher scores indicate lower degrees of safety.

At step 208, the data processing system segments one or more video recordings of at least one of the driving events that the data processing system detected from the visual data. In some cases, the data processing system can perform step 208 before step 206. For example, a computer (e.g., a computer of the data processing system), such as a computer including the onboard processor, on the vehicle may detect driving events from video streams captured by the camera of the vehicle. Responsive to detecting the driving events, the computer can automatically identify boundaries of the driving event. The computer can identify the boundaries to have a defined length (e.g., approximately 24 seconds or any other length) or have a length with a duration including the detected driving event. The computer can retrieve the video recording within the boundaries from the video stream and transmit the video recording to another computer (e.g., a remote processor or a cloud server) of the data processing system, in some cases with a label indicating the driving event and/or the driving event type of the video recording. The computer of the data processing system can receive the video recording and store the video recording in memory. The data processing system can use the video recording and/or the label to determine the driving score for the driver of the vehicle. The computers of the data processing system can operate in this manner for each driving event that the computers detect.

For example, the data processing system can segment video recordings of driving event types corresponding to stopping in the middle of a crosswalk. To do so, the data processing system can identify images and/or video segments of video streams that depict the vehicle approaching a crosswalk and stopping before the crosswalk and/or stopping in the middle of the crosswalk. The data processing system can set boundaries for the respective video recordings in the images and/or video streams. The data processing system can retrieve the video recordings from the sets of images and/or video streams based on the boundaries and transmit the video recordings to a remote computing device of the data processing system.

In some cases, the data processing system may only segment video recordings of negative driving events. For instance, continuing with the example above, the data processing system may only retrieve video recordings of visual data that depict the vehicle stopping in the middle of crosswalks. The data processing system may identify such driving events based on the labels indicating the driving events are negative, for example. Such video recordings can later be used to illustrate the driver's bad driving behavior to the driver.

In some cases, the data processing system may only segment video recordings of positive driving events. For instance, the data processing system may only retrieve video recordings of visual data that depict the vehicle stopping prior to crosswalks. The data processing system may identify such driving events based on the labels indicating the driving events are positive, for example. Such video recordings can later be used to illustrate the driver's good driving behavior to the driver as recognition for the good driving behavior or otherwise to reinforce the good driving behavior.

In some cases, the data processing system may segment positive and negative driving events. For instance, the data processing system may retrieve video recordings of visual data that depict the vehicle stopping prior to crosswalks and stopping in the middle of crosswalks. Such video recordings can later be used to illustrate the driver's good driving behavior to the driver as recognition for the good driving behavior and bad driving behavior to show instances in which the driver could improve.

In some embodiments, the data processing system can segment the one or more video recordings responsive to determining the first score for the component of the driving score associated with the driving event type satisfies the first threshold. For example, the onboard processor of the data processing system can transmit a video stream to a remote computing device of the data processing system as the camera of the vehicle generates the video stream. The data processing system can identify the driving events for the driver that depict driving events of the driving event type from the video stream. Based on the driving events, the data processing system can determine a score for the driving event type as the first score for the driving event type.

Responsive to determining the first score satisfies the first threshold, the data processing system can segment out video recordings of the driving events of the driving event type associated with the first score. The data processing system can extract or retrieve the images and/or the video recordings of identified driving events from memory. In some cases, the data processing system can retrieve the images and/or video recordings by setting the boundaries of the driving events in one or more video streams generated from driving sessions based on the times in which the driving events respectively began and ended and retrieving the driving videos from the video streams. The data processing system can separate the segmented video recordings into separate files that each depict a different driving event of the driving event type.

The data processing system can store the segmented video recordings in memory. A computer of the data processing system remote from the vehicle can store such segmented video recordings in memory, for example. The data processing system can store the segmented video recordings in the account of the driver. For instance, the data processing system can identify the account of the driver that was driving the vehicle for which the driving events were detected. The data processing system can store the segmented video recordings in a data structure (e.g., database, table, or otherwise dedicated location in memory) that stores data for the account. In some cases, the data processing system can store the segmented video recordings in a data structure (e.g., the same data structure for the account or a different data structure) with an identifier of the account of the driver that can be used to query and/or retrieve the video recordings responsive to receiving a request (e.g., responsive to selection of a pointer to the location in memory of the video recordings).

In step 210, the data processing system presents a message to the driver. The data processing system can present the message to the driver in response to determining the first score satisfies the first threshold. The message may include one or more pointers (e.g., hyperlinks) through which the driver can view or access the segmented video recordings. The message can be configured such that the computing device through which the driver views the message will display the video recordings responsive to the driver selecting the pointer or link to the video recordings in the message. For example, the data processing system can generate a message in a push notification, an email, a short message service (SMS) message, a website message, a message through an application, etc. The data processing system can include text indicating that the driver should or needs to participate in virtual coaching sessions. In some cases, the data processing system can include an identification of the type of driving event for which the data processing system is transmitting the message in the message. The data processing system can include a pointer or link in the message that includes an address to the location in memory of the data processing system that stores the segmented video recordings of the driving events of the driving event type. The pointer or link can be selected from a user interface to cause the data processing system to provision access to the segmented video recordings to the computing device from which the data processing system received the selection. In one example, the pointer can be configured to redirect an application (e.g., a browser or an application dedicated to accessing the platform provided by the data processing system) executing on a computing device associated with the driver to access the segmented video recording or segmented video recordings (e.g., segment of video data). In some cases, the data processing system can also determine one or more scores for other driving event types have satisfied the first threshold or thresholds corresponding to the different driving event types (e.g., for the first time period) and include links to segmented video recordings for each such driving event type in the message.

The data processing system can point to all or a defined number of video recordings in the message. In some cases, the data processing system can point to a defined number of positive driving events in which the driver engaged in positive driving behavior and/or a defined number of negative driving events in which the driver engaged in negative driving behavior. In doing so, the data processing system can avoid overwhelming the driver with too many video recordings to watch.

The data processing system can transmit the message to a client computing device associated with the driver. In doing so, the data processing system can transmit the message to an electronic account associated with the driver and/or to an application (e.g., an application programming interface) executing by or stored on the client device that is configured to communicate with the data processing system. The data processing system can do so by identifying an identifier of the electronic account in the account of the driver. The data processing system can identify the electronic account, generate the message, and transmit the message to the electronic account to give the driver the ability to view or access the video recordings.

The data processing system can transmit messages containing pointers to video recordings of driving events of the driving event type to the client computing device at varying rates. For instance, the data processing system can transmit the messages hourly, daily, weekly, monthly, etc. The data processing system can determine a rate to send the messages based on the first score for the driving event type. For example, in some cases, the data processing system may send the messages for pointers to different video recordings at a higher frequency if the first score is lower and/or vice versa. In another example, the data processing system may gradually increase the frequency of the messages with different video recordings over time when the data processing system determines the first score has not changed (e.g., increased or decreased) by an amount that satisfies (e.g., an amount above or below) a threshold, such as within a time period or one or more time intervals.

In step 212, the data processing system generates a second score for the component of the driving score for the driving event type at a second time period after presenting the message configured to display the segmented video recordings of the driving events. For example, after transmitting the message to the client computing device of the driver (e.g., to the electronic account associated with the driver), the data processing system can continue monitoring, detecting, and/or labeling driving events that occurred while the driver was driving the vehicle and/or any other vehicles. After a second time period elapses (e.g., after a defined length of time), the data processing system can generate a second score for the component of the driving score associated with the driving event type based on the driving events of the driving event type that the data processing system that occurred or that the data processing system detected within the second time period. The data processing system can generate the second score using the same function or method as the function or method the data processing system used to generate the first score.

In some cases, the data processing system can extend the second time period. The data processing system can extend the second time period based on whether the driver interacted with the video recordings. For example, the data processing system can monitor whether the driver interacted with (e.g., initiated or completed playback of) the video recordings. The data processing system can determine whether the driver interacted with the video recordings based on whether the driver initiated or completed playback of one, all, or otherwise a defined number or portion of the video recordings. The data processing system can do so by flagging the videos with a status indicating whether the video recordings have completed or begun playback by the driver and identifying the statuses of the videos. Responsive to determining the driver had interacted with the video recordings, the data processing system may extend the second time period by a defined amount or by an amount proportional to the percentage or number of video recordings the driver watched. In doing so, the data processing system may give the driver a longer time to increase or improve the driver's driving score and/or score for the driving event type before instructing the vehicle to activate any alerts.

In step 214, the data processing system determines whether a change in value between the first score and the second score satisfies a second threshold. The data processing system can perform the determination at one or more points in time (e.g., at different time intervals) within a defined time period subsequent to presenting the message to the driver. For example, the data processing system can be configured to generate a second score (e.g., an updated second score) for the driving event type at set intervals or randomly after presenting the message and/or generating the first score for the driving event type within the defined time period. The data processing system can additionally or instead generate the second score after each driving event that the data processing system detects and/or each driving event of the driving event type that the data processing system detects. In some cases, the data processing system only generates the second score at the end of the time period (e.g., only once at the end of the time period). The data processing system can determine a change in value between the first score and the second score and compare the change in value to the second threshold for each update or generation to determine whether the second score satisfies the second threshold. The data processing system can determine the change in value satisfies the second threshold responsive to determining the change in value exceeds or is less than the second threshold, depending on the configuration of the data processing system. For example, the data processing system can determine the second threshold is satisfied responsive to determining the score increased by an amount above the second threshold. If the data processing system determines at least one change in value between the scores satisfies the second threshold, the data processing system can transmit a message to the client computing device of the driver and/or return to the step 202, at least for the driving event type associated with the comparison.

In response to determining the change in value between the first and the second scores does not satisfy the second threshold (e.g., the score for the driving event type did not improve by at least a predetermined amount) at the end of the time period, in step 216, the data processing system instructs the vehicle to activate an audio or visual alert. In some cases, the alert can additionally or instead include a haptic alert. The data processing system can instruct the vehicle to activate the alert by generating a message containing instructions for the vehicle to activate the alert responsive to detection of a new driving event. The message may include instructions that, upon execution, cause the vehicle or a computing device executing on the vehicle (e.g., a computing device of the data processing system) to activate the alert when the vehicle or the data processing system detects a driving event. Thus, the data processing system may selectively configure the vehicle to generate alerts only after determining virtual driving sessions did not cause the driver to drive safer a defined time period after the video recordings of the virtual driving sessions were generated or a message configured to display the video recordings was presented to the driver.

The data processing system may instruct the vehicle responsive to detection of new events of the driving event type for which the data processing system generated virtual coaching sessions. For example, the data processing system may determine that a score for the driving event type of stopping at stop signs did not increase by at least a predetermined amount after presenting a message configured to display segmented video recordings of the driver failing to stop at stop signs within a defined time period. Responsive to the determination, the data processing system may generate instructions that are configured to cause the vehicle to generate an audible, visual, and/or haptic alert responsive to the vehicle or otherwise the data processing system detecting a stop sign within a defined distance (e.g., a set distance or a distance proportional to the velocity or speed of the vehicle) of the vehicle the driver is driving. The data processing system can instruct the vehicle according to the instructions to configure the vehicle to generate alerts according to the instructions. In some cases, the data processing system can detect such driving events and automatically cause the vehicle to generate alerts responsive to detecting the driving events of the driving event type in real time. In some cases, the data processing system may generate alerts responsive to detecting the driving events of the driving event type in real time, provided that the data processing system has already determined that the driver for whom the alerts are to generated is the person currently driving the vehicle.

In some cases, the data processing system can escalate virtual coaching sessions to managed coaching sessions. The data processing system may do so responsive to determining a driver has not improved by an amount above a threshold after instructing the vehicle to activate alerts for a driving event type. For example, after the instructing the vehicle to generate alerts for a particular event type, the data processing system may continue to monitor the performance of the driver. The data processing system may monitor the performance of the driver for a time period (e.g., a third time period) after instructing the vehicle to generate the alerts. The data processing system may detect driving events of the driving event type for the time period and generate a third score for the driving event type at the end or responsive to detecting the end of the time period. The data processing system may determine a change in value between the second score and the third score for the driving event type and compare the change in value to a third threshold. Responsive to determining the change in value satisfies the third threshold (e.g., is not an increase by an amount above or below the third threshold, depending on the configuration), the data processing system may escalate the virtual coaching session for the driver to a managed coaching session involving an in-person or online meeting between the driver and a driving coach.

To escalate the virtual coaching sessions to managed coaching sessions, the data processing system may instantiate (e.g., automatically instantiate) a video conference portal between the account of the driver and an account of the driving coach. The video conference portal can be a virtual session in which the driver and the driving coach can have a chat online over a network. In one example, the data processing system can instantiate the video conference portal by sending calendar invitations to the different accounts that include a link to a virtual session that the accounts can access to communicate with each other. In another example, the data processing system can send a link to the different accounts that provides access to the video conference portal with an indication of the time and/or date for the managed coaching session. In doing so, the data processing system may enable the driver to have a higher level of coaching to improve the driver's driving and thus make the roads a safer place.

In some cases, the data processing system may instruct the vehicle to stop activating the alert after the initial instruction to start activating the alert. The data processing system may do so in a few manners. In one example, the data processing system may

determine the score for the driving event type satisfies a third threshold (e.g., third predetermined threshold) subsequent to instructing the vehicle to activate the audio or visual alert. The data processing system may do so by recalculating the score for the driving event after detecting each driving event (e.g., each driving event of the driving event type) and comparing the recalculated score to the third threshold or by calculating the score for the driving event type at the end of a defined time period after instructing the vehicle to activate the alert and comparing the generated alert to the third threshold. Responsive to determining the score for the component of the driving score satisfies the third threshold, the data processing system can transmit an instruction to the vehicle to stop activating the audio or visual alert for new driving events of the driving event type. In another example, the data processing system can determine the driver has interacted with the one or more video recordings (e.g., using the methods described above) subsequent to instructing the vehicle to activate the audio or visual alert. Responsive to determining the driver has interacted with the one or more video recordings, the data processing system can generate and/or transmit an instruction to the vehicle to stop activating the audio or visual alert for new driving events of the driving event type.

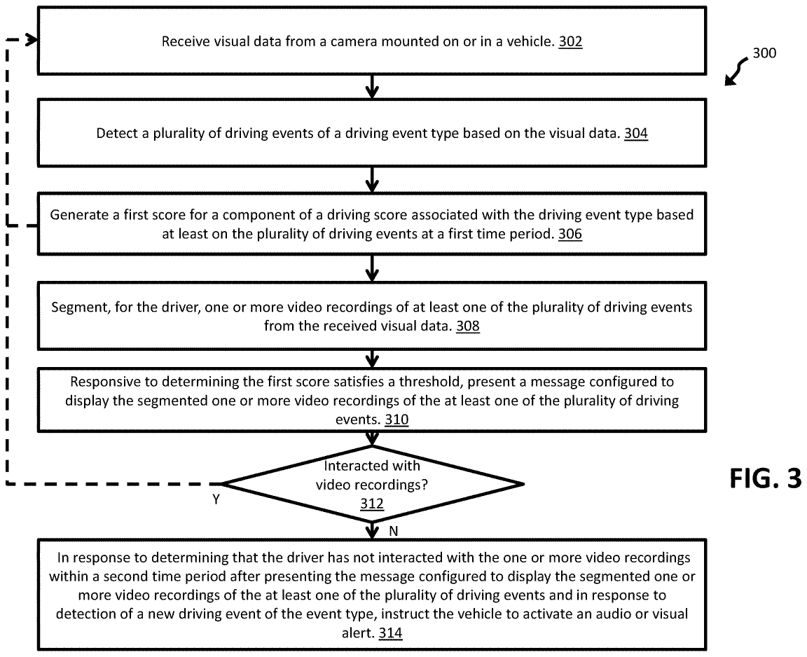

FIG. 3 illustrates a flow of a method 300 executed by a data processing system. The data processing system can be or include a computing system of a vehicle (e.g., the object detection system 105) and/or a remote computing system (e.g., a cloud server or the cloud computing system 115) for selective alert generation, in accordance with an embodiment. The method 300 includes steps 302-314. However, other embodiments may include additional or alternative steps, or may omit one or more steps altogether. Different steps can be performed by different computing systems (e.g., the computing system of the vehicle can perform one or more of the steps 302-314 and/or the remote computing system can perform one or more of the steps 302-314) and/or the different computing systems and can operate together to perform individual steps of the steps 302-314. The data processing system can perform one or more of the steps 302-314 in the same manner and/or while performing one or more steps of the method 200.

In step 302, the data processing system receives visual data. In step 304, the data processing system detects a plurality of driving events of a driving event type based on the visual data. The driving events can be driving incidents that occurred when a driver was driving a vehicle. In step 306, the data processing system generates a first score for a component of a driving score associated with the driving event type. The data processing system can generate the first score based at least on the plurality of driving events of the driving event type that occurred or that were detected during a first time period. In step 308, the data processing system segments, for the driver driving the vehicle during the driving events, one or more video recordings of at least one of the plurality of driving events (e.g., at least one driving event of the driving event type) from the received visual data. Responsive to determining the first score satisfies a threshold, in step 310, the data processing system presents, to the driver, a message configured to display the segmented one or more video recordings of the at least one of the plurality of driving events. The data processing system may transmit the message to a computing device or an electronic account associated with the driver. The data processing system may perform steps 302-310 while performing corresponding steps 202-210 or in the same manner as described above with respect to steps 202-210.

In step 312, the data processing system determines whether the driver has interacted with the segmented one or more video recordings of driving events of the driving event type. For example, after presenting or transmitting the message with pointers to locations in memory of the data processing system in which the segmented one or more video recordings are located to the client computing device or electronic account associated with the driver, the data processing system may monitor or maintain a record of the status of video recordings. The status may be a flag indicating whether the driver has viewed or accessed the video recordings (e.g., a status may be a binary indicator of whether the driver has initiated and/or completed playback of the individual video recordings). The data processing system may set such a status for each of the video recordings. The data processing system may initialize the status as unwatched for each video recording upon storing the video recordings in memory and/or presenting the message to the driver. The data processing system may update the status for the individual videos upon detecting the driver has at least started playback of the videos or has completed playback of the individual videos. The data processing system can determine whether the driver has interacted with the video recordings by identifying the statuses of the respective video recordings responsive to the end of a second time period after transmitting the message to the driver.

The data processing system can determine the driver interacted with the video recordings based on one or more criteria. For instance, in one example, the data processing system can determine the driver interacted with the video recordings responsive to determining the driver initiated or completed playback of at least one of the video recordings. In another example, the data processing system can determine the driver interacted with the video recordings responsive to determining the driver initiated or completed playback of all of the video recordings. In another example, the data processing system can determine the driver interacted with the video recording responsive to determining the driver watched at least a predetermined percentage (e.g., a percentage set by an administrator) of the video recordings. In another example, the data processing system can determine a level of engagement for the driver based on the number of the video recordings the driver played back. The data processing system may determine the driver did not interact with the video recordings responsive to the level of engagement being less than a threshold (e.g., a second threshold). The data processing system may determine whether the driver interacted with the video recordings in any manner.

In some cases, the data processing system only begins monitoring the account of the driver for interactions with the video recordings responsive to determining the score for the driving event type has not increased or changed by an amount above a threshold. For example, the data processing system may determine a change in value of the scores for the driving event type between the time in which the data processing system presented the message for the video recordings and a defined time period (e.g., a second time period). The data processing system may compare the change in value to a threshold (e.g., a predetermined threshold). Responsive to determining the change in value does not satisfy the threshold, the data processing system may begin monitoring (e.g., setting the status flags or checking the status flags of the video recordings) the account of the driver to determine if the driver has watched the video recordings.

The data processing system can perform the determination of whether the driver interacted with the one or more segmented video recordings at one or more points in time (e.g., at different time intervals) within a defined time period subsequent to presenting the message to the driver. For example, the data processing system can be configured to determine whether the driver has interacted with the segmented one or more video recordings at set intervals or randomly after presenting the message and/or generating the first score for the driving event type within the defined time period. In some cases, the data processing system can be configured to determine whether the driver has interacted with the segmented one or more video recordings at the end of the time period (e.g., once at the end of the time period). If the data processing system determines the driver has interacted with the one or more video recordings at least once within the time period or at the end of the time period, the data processing system can transmit a message to the client computing device of the driver and/or return to the step 302, at least for the driving event type associated with the determination.

In response to determining the driver did not interact with the video recordings (e.g., within the defined time period), in step 314, the data processing system instructs the vehicle to activate an audio, visual, and/or haptic alert. The data processing system can instruct the vehicle to activate the alert responsive to detection of new events of the same event type for which the data processing system segmented the video recordings. The data processing system can instruct the vehicle to activate alerts in the same or a similar to the manner described above with respect to step 216. The data processing system may be configured to instruct the vehicle to activate alerts responsive to determining the driver did not interact with the video recordings in addition to responsive to determining the score for the type of driving event did not increase by at least a predetermined amount (e.g., the data processing system may instruct the vehicle to generate alerts in response to one of the conditions occurring or both of the conditions occurring).

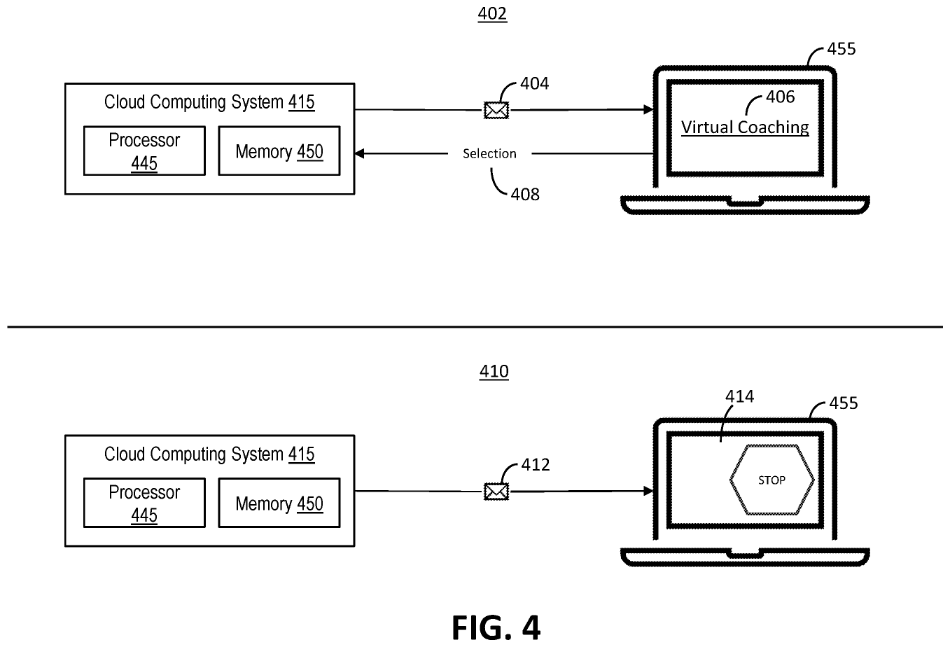

FIG. 4 illustrates a sequence 400 for presenting segmented video recordings of driving events, according to an embodiment. One or more operations of the sequence 400 can be performed by a cloud computing system 415 (having processor 445 and memory 450, such as cloud computing system 115 in FIG. 1) and/or a client computing device 455 (such as client computing device 155 in FIG. 1). In some cases, the computing device 120 can be configured to do one or more of the operations (e.g., in place of the cloud computing system 415). Performance of the sequence can enable a driver accessing the client computing device 455 to view video recordings of virtual coaching sessions segmented by the cloud computing system 415.

For example, in an operation 402, the cloud computing system 415 can transmit a message 404 to the client computing device 455. The message 404 can be a message configured to present one or more video recordings of driving events of a driving event type to a driver accessing the client computing device 455. The cloud computing system 415 can transmit the message 404 to the client computing device 455 responsive to determining a score for the driving event type for the driver satisfies a threshold or satisfies any other criteria, for example. The client computing device 455 can receive the message 404 and display or present a pointer 406 from the message 404 on a user interface displayed on the client computing device 455. The driver can select the pointer 406 from the user interface using an input/output device (e.g., a touchscreen or mouse). Responsive to the selection, the client computing device 455 can transmit a message 408 containing the selection to the cloud computing system 415.

In an operation 410, the cloud computing system 415 can receive the message 408 containing the selection from the client computing device 455. Responsive to receiving the message 408, the cloud computing system 415 can query memory for the video recordings corresponding to the selection. The cloud computing system 415 can identify the video recordings and transmit the video recordings to the client computing device 455 in a message 412. The client computing device 455 can receive the message 412 and present the video recordings on a user interface 414 (e.g., via a video player) to the driver.

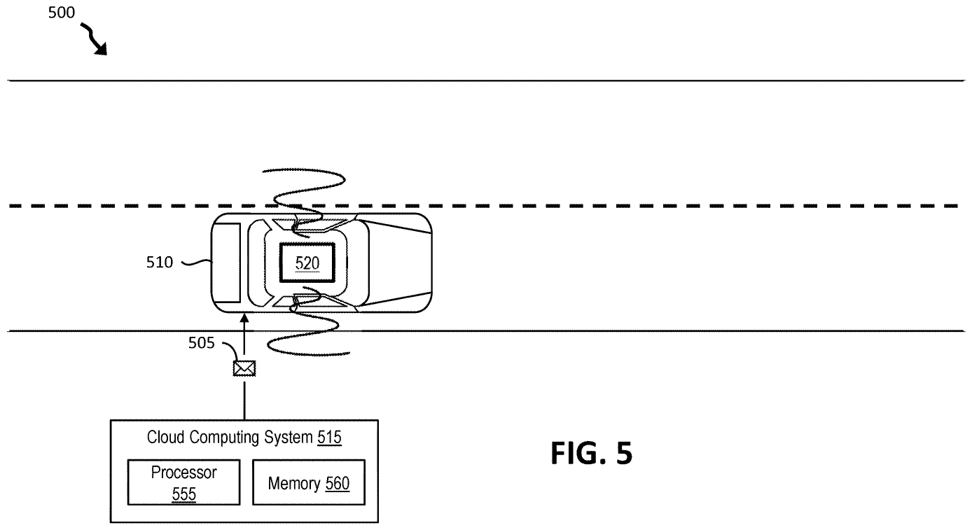

FIG. 5 illustrates a scenario 500 in which the cloud computing system 515 (having processor 555 and memory 560) instructs a vehicle 510 to activate alerts for driving events of a driving event type, according to an embodiment. In the scenario 500, the cloud computing system 515 can transmit a message 505 that contains instructions to activate alert devices 520 (e.g., lights, speakers, haptic feedback devices, etc.) within or on the vehicle 510. The cloud computing system 515 may generate and/or transmit the message 505 containing the instructions responsive to determining the driver of the vehicle 510 has not interacted with video recordings of virtual training sessions that the cloud computing system 515 generated within a defined time period and/or responsive to determining the driver has not improved his or her score for the driving event type of the video recordings within a defined time period. The vehicle 510 can receive (e.g., via the computing device 520) the message 505 can operate to activate the alert devices 520 responsive to detecting driving events of the driving event type, in some cases based on the driving event type being identified in the message 505.

### Automated Coaching Workflows

Certain aspects of the present disclosure generally relate to systems and methods to encourage and solidify safe driving habits, and more particularly to systems and methods of managing coaching workflows, including by using an event or time-based trigger to automatically resolve a task assigned to a safety manager. Other aspects of the present disclosure generally relate to systems and methods to encourage and solidify safe driving habits, and more particularly to systems and methods of providing coaching resources in a progressive fashion.

Large transportation fleets want to consistently apply safety practices across all drivers, who may be in geographically diverse locations. For safety systems that incorporate inputs and/or guidance from human safety experts (coaches), tasks that are assigned to coaches may exceed the capacity of the human coach, causing certain workflows to become stuck and leaving certain safety issues unaddressed. The present disclosure addresses challenges with the consistent application of coaching resources, such as by mitigating risks associated with incomplete or uneven resolution of coaching tasks.

Certain aspects of the present disclosure generally relate to providing, implementing, and using automated/virtual (e.g., self-coaching) and face-to-face (e.g., managed coaching) coaching resources.

Certain aspects of the present disclosure provide a method. The method includes creating a virtual coaching session for a driver, wherein the virtual coaching session comprises video recordings of driving safety events that the driver may review alone. The method further includes determining a level of engagement with the virtual coaching session by the driver, and then modifying a managed coaching session priority based on the determined level of engagement.

Certain aspects of the present disclosure provide a method. The method comprises creating a managed coaching session for a driver, wherein the managed coaching session comprises video recordings of driving safety events that the driver may review together with a safety manager; assigning the managed coaching session to the safety manager; determining a reassignment trigger based on a passage of time; a coaching workflow volume; a coaching availability state, or a combination thereof, and reassigning the managed coaching session to a virtual coaching session based on the reassignment trigger.

Certain aspects of the present disclosure describe a fleet enjoying the benefits of fully automated and frictionless coaching while still ensuring accountability and consistent improvement of safety practices.

A driver safety program may involve inputs from a safety expert who may provide guidance, provide positive recognition, and/or resolve disputes from drivers. The safety expert may be a safety manager or coach employed by a transportation fleet. Within the context of a driver safety program, the safety manager may be assigned (or may initiate) coaching tasks.

### Automatic Re-assignment of Managed-coaching Coaching Sessions

In some embodiments, a virtual safety manager system may automatically create coaching sessions, where the coaching sessions include video and/or other driving data that were detected and automatically characterized as safety events by vehicular safety devices (such as the Netradyne® Driver. i®) that are installed in a fleet's vehicles. The automatic creation of coaching sessions and the assignment of such coaching sessions to a safety manager to review with a driver may create numerous benefits. In some situations, however, the safety manager may fall behind in the assigned coaching tasks, which may leave the content of the assigned coaching tasks unaddressed.

In some embodiments of the present disclosure, a managed coaching session may be created for a driver. A managed coaching session may refer to one or more video recordings of driving safety events that the driver may review together with a safety manager. The managed coaching session may be assigned to the safety manager (or coach, third-party expert, and the like). In some embodiments, the assigned managed coaching session may be added to a queue of such sessions that have been assigned to the safety manager over a period of time. The queue may be viewable in a web portal. The managed coaching sessions may include status indicators such as pending or completed. In certain circumstances, a reassignment trigger may be determined. For example, based on a passage of time, a coaching workflow volume, a coaching availability state, or a combination of such factors, a reassignment may be triggered. Based on the trigger, the managed coaching session may be reassigned to a virtual coaching session. The virtual coaching session may include all or some of the content of the managed coaching session. The virtual coaching may be distinguished from the managed coaching session by mode of delivery. For example, the virtual coaching session may be delivered to the driver directly via a smartphone app. The driver may then review the virtual coaching session alone. The virtual coaching session may include review of video recordings of the driving safety events that were assembled into the virtual coaching session.

The automated systems and methods of reassigning a coaching session just described (from managed to virtual/self) are expected to cause the driver to improve driving safety habits overall, since it can be considered a technique to enable integration of a safety manager into an otherwise automated coaching workflow. In some embodiments, the creation of managed coaching sessions may be reserved for drivers who are working to improve driving safety habits that are difficult to overcome using self-coaching techniques alone. If the safety manager fails to act on the managed coaching sessions, however, then the driving safety habits in question may be effectively ignored for a period of time. In such a situation, by re-assigning the content of the coaching session to a self-coaching mode, the driver may still benefit from timely feedback on the safety habit. This feedback, although originally scheduled for review with a safety manager, will still help the driver to solidify safer driving habits around the driving behaviors that are the subject of the reassigned coaching session.

In some embodiments, upon re-assigning (or creating) a virtual coaching session, the driver's level of interaction with the virtual coaching session may be monitored. Levels of engagement may be enumerated, such as: did not open the virtual coaching session (or otherwise respond to a notification of the virtual coaching session); opened the virtual coaching session but did not provide any feedback or dispute any alerts; opened the virtual coaching session and did provide feedback or disputed an alert. Feedback may refer to a driver acknowledging that the safety event was accurate. Disputing an alert may refer to a driver questioning that the detection of a safety event was accurate. Resolution of disputed safety events is discussed in the next session.

According to certain aspects, the driver's level of engagement with a coaching session may be used as the basis for managing a managed coaching session priority. The managed coaching session priority may refer to the priority for which a driver may be selected for a coaching session together with a safety manager. The priority may be higher for drivers who are more likely to get into collisions. Based on the recognition that drivers who engage in self-coaching methods may be less likely to get into collisions in comparison to drivers who do not engage in self-coaching methods, the system may use the measure of engagement to increase or decrease the driver's managed coaching sessions priority.

### Automatic Resolution of Disputed Safety Events

When a driver reviews a safety event alone (or together with a manager), the driver may want to dispute the accuracy of the detected safety event and/or complain that it is unfair. Not only are automated safety event detection systems sometimes wrong, such systems may be tuned to classify events in a manner that the fleet operator and/or safety manager would not agree with. In addition, there may be additional contextual factors that might warrant changing a characterization of a safety event from unsafe to safe, from severe to moderate, or even from unsafe to an example of positive, exemplary driving.

There are multiple reasons why a driver may review safety events (associated with the driver's driving) alone. For example, the driver may have proactively requested access to video associated when a driver received an in-cab notification, the automated system may have assigned the driver a self-coaching session (a “virtual” coaching session), or the safety manager have been assigned a managed coaching session for the driver but the safety manager may not have acted upon that within a threshold period of time. An alternative trigger for re-assignment of managed coaching sessions may be based on a determination that the safety manager's managed-coaching queue may have exceeded a threshold making on-time review unlikely. In some embodiments, the safety manager may have re-assigned the session without first reviewing it, although this pathway to reassignment may suffer from human-related biases and incompleteness, which certain aspects of the present disclosure generally aim to avoid.

When a driver reviews video associated with safety events, the driver may dispute the accuracy of any event. In some embodiments, to improve accountability, disputed alerts may be assigned to another person, such as the safety manager, an independent expert, or other neutral third party. The safety manager (or other person) may then be assigned the task of reviewing the accuracy such automatically detected safety events.

In some embodiments, some video reviews may be selected at random, or otherwise algorithmically, so as to avoid the sampling bias from relying on active dispute by drivers. In a hybrid mode, some reviews may originate based on inputs from drivers or other safety managers, and some may originate based on random sampling. Having interested parties involved in checking the accuracy of alerts may lead to faster improvements to a safety system overall.

When a driver disputes the accuracy of an alert (a determination by the safety device of a safe or unsafe driving event) in the context of a self-coaching session, the safety manager may then be assigned the task of resolving the dispute. The safety manager may resolve the dispute by reviewing video data captured at the time of the disputed event (the alert). The safety manager may communicate a judgement by pressing one or more buttons on a display, by typing a rationale in a text box, and the like.

If the safety manager agrees that the detected event was in error, then the result of this judgement may be received and used as the basis to modify a managed coaching session priority. In this way, the dispute resolution process may driver further efficiency and effectiveness of the overall safety system by more accurately allocating managed coaching session resources.

While dispute resolution is beneficial, dispute resolution may also cause excessive workflow demands on a safety manager (or other expert). According to certain aspects, the system may automatically “judge” a disputed safety alert based on the passage of time (or similar workflow-based criteria). In this way, the overall system may benefit from the accountability associated with the safety manager or other third-party review of disputed alerts, but may also manage excessive workflow demands in a fair and balanced manner.

In one aspect, the present disclosure describes a method. The method may include creating a virtual coaching session for a driver, wherein the virtual coaching session comprises video recordings of driving safety events that the driver may review alone; determining a level of engagement with the virtual coaching session by the driver; and modifying a managed coaching session priority based on the determined level of engagement.

The method may further include receiving, from the driver, a disputed designation for a safety event within the virtual coaching session; transmitting an indication of the disputed alert to the safety manager; and receive a judgement from safety manager, wherein the managed coaching session priority modification is further based on the judgement.

The judgement may be automatic based on a passage of time, a coaching workflow volume, a coaching availability state, or a combination thereof, without input from safety manager.

There may be a cap to how many disputed safety events may be automatically judged in favor of the driver for a time period.

The disputed safety event may be an example of a driving scenario and a recorded behavior of the driver in the driving scenario. The cap may be based on a predetermined accuracy of the safety system with respect to the driving scenario.

The level of engagement may be one of driver did not open coaching session; driver opened coaching session but did not provide feedback or dispute any safety event; or driver opened coaching session and provided feedback on or disputed at least one safety event.

The feedback may include an acknowledgment of the accuracy of a safety event.

The feedback may include a judgment by the driver asked to determine which of two recorded safety events is more unsafe.

Disputing a safety event may include giving a reason.

The method may further include creating a managed coaching session for a driver, wherein the managed coaching session comprises video recordings of driving safety events that the driver may review together with a safety manager; assigning the managed coaching session to the safety manager; determining a reassignment trigger based on a passage of time; a coaching workflow volume; a coaching availability state, or a combination thereof, and reassigning the managed coaching session to the virtual coaching session based on the reassignment trigger.

In one aspect, the method may include creating a managed coaching session for a driver, wherein the managed coaching session comprises video recordings of driving safety events that the driver may review together with a safety manager; assigning the managed coaching session to the safety manager; determining a reassignment trigger based on a passage of time, a coaching workflow volume, a coaching availability state, or a combination thereof, and reassigning the managed coaching session to a virtual coaching session based on the reassignment trigger.

In one aspect, a method includes receiving driving data associated with a driver; receiving engagement data for the driver, wherein the engagement data indicates whether the driver engages with or is otherwise responsive to, one or more automated coaching resources; and determining whether to generate an assigned coaching session for the driver based on the driving data and the engagement data.

Personal data of the driver may not be shared with a safety manager or other human coach unless the determination results in the assignment of a coaching session.

Personal data of the driver may not be shared with a safety manager or other human coach unless the determination results in the assignment of a coaching session and the driver does not engage with the assigned coaching session within a predetermined period of time.

In one aspect, a method includes receiving driving data associated with a driver; receiving engagement data for the driver, wherein the engagement data indicates whether the driver engages with or is otherwise responsive to, one or more automated coaching resources; and generate a recognition award based on the driving data and the engagement data.

A computer program product may include a non-transitory computer-readable medium having instructions stored thereon, the instructions being executable by one or more processors configured to carry out any of the systems and/or methods described herein.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The operations described in this specification can be implemented as operations performed by a data processing apparatus on data stored on one or more computer-readable storage devices or received from other sources.

The terms “data processing apparatus”, “data processing system”, “client device”, “client computing device”, “computing platform”, “computing device”, “computing system”, “user device”, or “device” can encompass all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a GPS receiver, a digital camera device, a video camera device, or a portable storage device (e.g., a universal serial bus (USB) flash drive), for example. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD monitor, for displaying information to the user; a keyboard; and a pointing device, e.g., a mouse, a trackball, or a touchscreen, by which the user can provide input to the computer. Other kinds of devices can be used to provide for interaction with a user as well; for example, feedback provided to the user can include any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user.

In certain circumstances, multitasking and parallel processing system may be advantageous. Moreover, the separation of various system components in the implementations described above should not be understood as requiring such separation in all implementations, and it should be understood that the described program components and systems can generally be integrated together in a single software product or packaged into multiple software products. For example, the computing devices described herein can each be a single module, a logic device having one or more processing modules, one or more servers, or an embedded computing device.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or”may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

1. A method, comprising:
receiving, by one or more processors, visual data from a camera mounted on or in a vehicle;
detecting, by the one or more processors, a plurality of driving events of a driving event type based on the visual data, the plurality of driving events corresponding to a driver driving a vehicle during the plurality of driving events;
generating, by the one or more processors, a first score for a component of a driving score associated with the driving event type based at least on the plurality of driving events at a first time period;
segmenting, by the one or more processors for the driver, one or more video recordings of at least one of the plurality of driving events from the received visual data;
responsive to determining the first score satisfies a first threshold, presenting, by the one or more processors, a message configured to display the segmented one or more video recordings of the at least one of the plurality of driving events;
generating, by the one or more processors, a second score for the component of the driving score at a second time period after presenting the message configured to display the segmented one or more video recordings of the at least one of the plurality of driving events; and
in response to determining a change in value between the first score and the second score does not satisfy a second threshold and in response to detection of a new driving event of the driving event type, instructing, by the one or more processors, the vehicle to activate an audio or visual alert.

2. The method of claim 1, wherein detecting the plurality of driving events of the driving event type comprises detecting, by the one or more processors, the plurality of driving events using a machine learning model on one or more features depicted in the visual data.

3. The method of claim 2, wherein detecting the plurality of driving events of the driving event type using the machine learning model comprises detecting, by an onboard processor located in or on the vehicle of the one or more processors, the plurality of driving events of the driving event type using the machine learning model.

4. The method of claim 1, wherein segmenting the one or more video recordings of the at least one of the plurality of driving events comprises:
generating, by the one or more processors, a segment of video data for each of the at least one of the plurality of driving events, each segment depicting a different driving event of the at least one of the plurality of driving events; and
storing, by the one or more processors, the segment of video data for each of the at least one of the plurality of driving events in a location in memory with an identifier of an account of the driver.

5. The method of claim 4, wherein presenting the message configured to display the segmented one or more video recordings of the at least one of the plurality of driving events comprises:
transmitting, by the one or more processors, the message comprising a pointer to the location in memory to a computing device associated with the account of the driver, the pointer configured to redirect an application executing on the computing device to access the segment of video data for each of the at least one of the plurality of driving events.

6. The method of claim 1, further comprising:
determining, by the one or more processors, the second score for the component of the driving score satisfies a third threshold subsequent to the instructing the vehicle to activate the audio or visual alert; and
responsive to determining the second score for the component of the driving score satisfies the third threshold, transmitting, by the one or more processors, an instruction to the vehicle to stop activating the audio or visual alert for the driving event type.

7. The method of claim 1, further comprising:
determining, by the one or more processors, the driver has interacted with the one or more video recordings; and
responsive to determining the driver has interacted with the one or more video recordings, transmitting, by the one or more processors, an instruction to the vehicle to stop activating the audio or visual alert for the driving event type.

8. The method of claim 1, comprising:
responsive to determining, by the one or more processors, that the driver has interacted with the one or more video recordings, extending, by the one or more processors, the second time period; and
generating, by the one or more processors, the second score for the component of the driving score at the extended second time period after the presenting the message configured to display the segmented one or more video recordings of the at least one of the plurality of driving events.

9. The method of claim 1, further comprising:
in response to determining a change in value between the second score and a third score for the component of the driving score generated at a third time period after generation of the second score satisfies a third threshold, instantiating, by the one or more processors, a video conferencing portal between an account of the driver and an account of a driving coach.

10. The method of claim 1, further comprising:
in response to determining a change in value between the first score and the second score does not satisfy the second threshold and in response to the detection of the new driving event of the driving event type, instructing, by the one or more processors, the vehicle to activate haptic feedback of one or more devices within the vehicle.

11. A system comprising:
one or more processors configured by machine-readable instructions to:
receive visual data from a camera mounted on or in a vehicle;
detect a plurality of driving events of a driving event type based on the visual data, the plurality of driving events corresponding to a driver driving a vehicle during the plurality of driving events;
generate a first score for a component of a driving score associated with the driving event type based at least on the plurality of driving events at a first time period;
segment, for the driver, one or more video recordings of at least one of the plurality of driving events from the received visual data;
responsive to determining the first score satisfies a first threshold, present a message configured to display the segmented one or more video recordings of the at least one of the plurality of driving events;
generate a second score for the component of the driving score at a second time period after presenting the message configured to display the segmented one or more video recordings of the at least one of the plurality of driving events; and
in response to determining a change in value between the first score and the second score does not satisfy a second threshold and in response to detection of a new driving event of the driving event type, instruct the vehicle to activate an audio or visual alert.

12. The system of claim 11, wherein the one or more processors are configured to detect the plurality of driving events of the driving event type by detecting the plurality of driving events using a machine learning model on one or more features depicted in the visual data.

13. The system of claim 12, wherein an onboard processor located in the vehicle of the one or more processors is configured to detect the plurality of driving events of the driving event type using the machine learning model.

14. The system of claim 11, wherein the one or more processors are configured to segment the one or more video recordings of the at least one of the plurality of driving events by:
generating a segment of video data for each of the at least one of the plurality of driving events, each segment depicting a different driving event of the at least one of the plurality of driving events; and
storing the segment of video data for each of the at least one of the plurality of driving events in a location in memory with an identifier of an account of the driver.

15. The system of claim 14, wherein the one or more processors are configured to present the message configured to display the segmented one or more video recordings of the at least one of the plurality of driving events by:
transmitting the message comprising a pointer to the location in memory to a computing device associated with the account of the driver, the pointer configured to redirect an application executing on the computing device to access the segment of video data for each of the at least one of the plurality of driving events.

16. The system of claim 11, wherein the one or more processors are further configured to:
determine the second score for the component of the driving score has satisfies a third threshold subsequent to the instructing the vehicle to activate the audio or visual alert; and
responsive to determining the second score for the component of the driving score satisfies the third threshold, transmit an instruction to the vehicle to stop activating the audio or visual alert for the driving event type.

17-20. (canceled)
